(19) United States
(12) Patent Application Publication
(10) Pub. No.: US 2009/0139301 A1
(43) Pub. Date: Jun. 4, 2009

(54) APARATUS AND METHOD FOR CALIBRATING THE SENSITIVITY OF A MOISTURE SENSOR

(76) Inventor: Metin Ata Gunsay, (US)

Correspondence Address: Metin Ata Gunsay, 136 E. Steep Mountain Dr., Draper, UT, 84020, US

(21) Appl. No.: 11/947,931

(22) Filed: Nov. 30, 2007

(51) Int. Cl. G01F 25/00

(52) U.S. Cl. 73/1.73

(57) ABSTRACT

A water moisture sensor calibration apparatus, comprising: a moisture sensor probe whose surface is marked with graduated lines, text or other markings, whereby the probe may be inserted to calibrate the sensitivity or the dry/moist threshold value of the sensor to a defined level.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

This invention generally relates to moisture sensing; specifically to an improved method and apparatus for calibrating the sensitivity and threshold level of a moisture— sensing device.

2. Prior Art

A variety of moisture sensing probes and monitoring devices have been developed, wherein a user monitors bulk materials by inserting an elongated probe into a material being tested.

These devices find application in measuring the moisture content of bulk food products, soil in agricultural applications, and the moisture content of soil in potted plants. In the application of monitoring soil, the water hold capacity of soil can vary greatly according to the soil composition. For example, sandy soils often have poor water holding capability.

Typically, moisture monitoring devices either visually or audibly indicate moisture or dryness after a dry/moist threshold is reached, or they indicate a continuum of moisture levels. In cases where the soil composition varies, the wet/dry threshold need to be adjusted, or in the case of monitors that display a continuum of moisture levels the sensitivity of the probe needs to be adjusted to the type of soil being monitored.

The ability for a user to change and calibrate the probe sensitivity or threshold of a monitoring device can be critical. In the case of monitoring the soil moisture in a potted plant, some plants require moisture levels different than others. For example, a cactus will require less watering, than other types of houseplants.

There are varying ways of calibrating the sensitivity or threshold of a monitoring device, for example, the most common practice is to use switches, or even magnetic switches to change the internal numerical threshold of the device. Other methods include providing a link to another computer device, which can download the calibration values. These methods add cost and can be cumbersome. These practices can also add to the difficulty of making the device watertight.

Many types of capacitive and transmission line based moisture sensor exist, but none provide an easy or cost effective method or apparatus for varying or arbitrarily setting the sensitivity level. For example, the sensors as shown in U.S. Pat. Nos. 6,904,789, 5,148,125, 5,445,178, 5,424,649, 5,148,125, 6,981,405 and 6,060,889, do not provide a means or method for varying the sensitivity of the measurements. Moisture sensors specifically designed for measuring the soil in potted plants, also suffer from this inability, as can be seen in U.S. Pat. Nos. 4,791,413, 4,268,824, 4,514,722, 4,931,775, 6,202,479, 6,198,398 and 6,700,39.

In view of the foregoing, there is a need for an apparatus and method for calibrating the sensitivity or dry/moist threshold of a moisture sensor, probe or other monitoring device, which keeps the device electronics watertight, is easy to use, requires no external computer link, and is cost effective.

### OBJECTS AND ADVANTAGES

Accordingly, several objects and advantages of the invention are: to simplify and reduce cost of calibrating the sensitivity or dry/wet threshold of a moisture sensor, probe or other monitoring device.

Still further objects and advantages will become apparent from a consideration of the ensuing description and drawings.

### SUMMARY

In accordance with the present invention, an apparatus and method for calibrating the sensitivity and moist/dry threshold of a moisture sensor, comprises a moisture sensor, line and text markings along the surface of the probe, for the purpose of calibrating the probe.

### DRAWINGS

### Figures

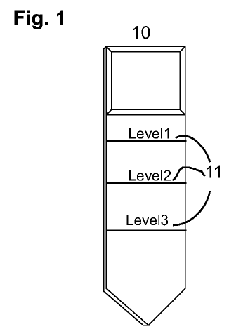

FIG. 1. is a perspective view of an embodiment a water moisture monitor according to the present invention.

### REFERENCE NUMERALS

10 moisture sensor
11 graduated lines and sample text

### DETAILED DESCRIPTION

### FIGS. 1—PREFERRED EMBODIMENT

A block diagram of the preferred embodiment is described in FIG. 1. A moisture sensor 10, is marked with graduated lines and/or text 11 along the surface of the probe, which is inserted into the soil or other medium under test. The text labels for each graduation on the diagram is provided as an example, but could be of a form to indicate type of soil or indicate if a plant is to be watered more or less frequently. The probe user merely adjusts the probe sensitivity by inserting the probe more deeply for applications where the dryness threshold should be lowered, and less deeply for applications requiring it to be raised. The user is guided in this calibration by the markings on the probe.

Numerous water moisture sensors are available whose sensitivity changes according to insertion depth, and can be used for this application, including those that can be incorporated onto a PCB board; some are transmission line base, others are capacitive in nature.

### CONCLUSION, RAMIFICATIONS, AND SCOPE

Accordingly the reader will see that, the moisture sensor calibration apparatus and method, is easy to use, watertight, requires no costly switches or computer link.

While the above description contains many specificities, these should not be construed as limitations on the scope of the invention, but as exemplifications of the presently preferred embodiments thereof. Many other ramifications and variations are possible within the teachings of the invention. For example, a variety of graduation lines, text and markings could be used.

Thus the scope of the invention should be determined by the appended claims and their legal equivalents, and not by the examples given.

What is claimed is:

1. A water moisture sensor calibration apparatus, comprising:
a. a moisture sensor probe whose surface is marked with
b. graduated lines, text or other markings, whereby the probe may be inserted to set the sensitivity or threshold value to a predefine level.

2. A method of setting the sensitivity of a moisture sensor or monitor, comprising the steps of:
a. providing an elongated moisture sensor probe;
b. inserting this probe into soil which is to be monitored at a depth proportional to the desired moisture sensitivity or wetness/dryness threshold of the sensor;

3. A method of setting the sensitivity of a moisture sensor or monitor, comprising the steps of:
a. providing an elongated moisture sensor probe whose surface is graduated with lines, text or other markings, which indicate the types of soil or mediums or sensitivity levels;
b. inserting the moisture sensor probe or monitor into soil which is to be monitored to a depth as indicated by the said graduated lines, text or other markings, to achieve the desired sensitivity or threshold value.
